(19) United States
(12) Patent Application Publication
(10) Pub. No.: US 2014/0250020 A1
(43) Pub. Date: Sep. 4, 2014

(54) SYSTEM AND METHOD FOR FORMING A LEGAL ENTITY USING A MOBILE DEVICE

(71) Applicant: In the Moment Legal LLC, Cincinnati, OH (US)

(72) Inventor: Michael P. Mooney, Cincinnati, OH (US)

(73) Assignee: In the Moment Legal LLC, Cincinnati, OH (US)

(21) Appl. No.: 14/187,937

(22) Filed: Feb. 24, 2014

Related U.S. Application Data
(60) Provisional application No. 61/851,173, filed on Mar. 4, 2013.

(51) Int. Cl. G06Q 10/00; G06Q 50/18

(52) U.S. Cl. CPC G06Q 10/00; G06Q 50/18
USPC 705/317

(57) ABSTRACT

An automated system is provided for forming a legal entity. The system comprises a database for storing a plurality of record files comprising legal forms for filing with government registration entities. A questionnaire memory stores a plurality of query lists to ascertain relevant data for legal forms. A mobile device is operatively associated with the computer database and the questionnaire memory. The mobile device includes a programmed processor, program memory, an input device for entering commands, a display and a wireless transceiver for remote communications. The processor runs an application program stored in the program memory. The application program maps select ones of the plurality of query lists to select ones of the legal forms and operates a user interface using the display through which a user enters commands on the input device including a selection of one of the plurality of legal forms. Responsive thereto, the application program displays the mapped query list for the selected legal form. The user responds to the queries using input commands, whereby the application program generates a completed legal form for electronic signature by the user using the input device and subsequent automatic communication of the signed legal form to the legal registration entity using the transceiver.

### CROSS-REFERENCE TO RELATED APPLICATIONS

This application claims priority of provisional application No. 61/851,173, filed Mar. 4, 2013.

### FEDERALLY SPONSORED RESEARCH OR DEVELOPMENT

Not Applicable.

### MICROFICHE/COPYRIGHT REFERENCE

Not Applicable.

### FIELD OF THE INVENTION

This invention relates to procedures for forming a legal entity, for example a corporation, and, more particularly, to a system and method for forming a legal entity using a mobile device.

### BACKGROUND

Various governmental bodies, particularly states and foreign countries, each have different procedures for forming a legal entity such as a corporation, limited liability company, limited partnership, or the like. As such, each governmental body requires the submission of unique forms before forming a legal entity.

To form a legal entity it is therefore necessary to obtain the appropriate forms, complete and sign the forms and forward them with the necessary payment to the appropriate governmental body. More recently, some forms have been available in electronic format to be filled out on a computer with the forms being subsequently forwarded in hard copy format or electronically to the appropriate governmental body, as may be provided for.

Under current practice it is necessary for a user to understand the form and what information is necessary to complete the form. The user must ensure that the appropriate information is entered into the appropriate places on the form. If improper or incomplete information is entered, then the form may be rejected. Also, the user must make provision for any necessary payments to be made. Each of these steps can slow down the process and may result in unnecessary costs.

The present invention is directed to forming a legal entity using a single transaction on a mobile device.

### SUMMARY

In accordance with the invention, a system and method are provided for forming a legal entity using a mobile device.

In one embodiment, an automated system is provided for forming a legal entity. The system comprises a database for storing a plurality of record files comprising legal forms for filing with state registration entities. A questionnaire memory stores a plurality of query lists to ascertain relevant data for legal forms. A mobile device is operatively associated with the computer database and the questionnaire memory. The mobile device includes a programmed processor, program memory, an input device for entering commands, a display and a wireless transceiver for remote communications. The processor runs an application program stored in the program memory. The application program maps select ones of the plurality of query lists to select ones of the legal forms and operates a user interface using the display through which a user enters commands on the input device including a selection of one of the plurality of legal forms. Responsive thereto, the application program displays the query list for the selected legal form. The user responds to the queries using input commands, whereby the application program generates a completed legal form for electronic signature by the user using the input device and subsequent automatic communication of the signed legal form to the legal registration entity using the transceiver.

It is a feature that the mobile processing device operatively communicates with the database using the transceiver. The transceiver may communicate with the database over the Internet.

It is another feature that the mobile processing device operatively communicates with the questionnaire memory using the transceiver.

It is a further feature that the record files include data representing cost for each of the plurality of legal forms wherein the application program, responsive to the user entering commands to select one of the plurality of legal forms, implements a payment routine for the costs associated with the select one of the plurality of legal forms.

It is yet another feature that the mobile processing device automatically communicates the signed legal form to a registered agent, identified responsive to one of the mapped queries, using the transceiver.

It is an additional feature that the application program is operative to save the signed legal form in the database.

It is yet another feature that the database stores a plurality of user profile files representing identification information and payment information for a user.

There is disclosed in accordance with another embodiment a method for forming a legal entity using mobile devices, comprising providing a database for storing a plurality of record files comprising legal forms for filing with state registration entities; providing a questionnaire memory for storing a plurality of query lists to ascertain relevant data for legal forms; a user operating an application program using a mobile processing device which is in operative communication with the computer database and the questionnaire memory, the application program mapping select ones of the plurality of query lists to select ones of the legal forms, and operating a user interface using a display through which a user enters commands on an input device, the commands including a selection of one of the plurality legal forms, and responsive thereto the application program displaying the query list for the selected legal form, and the user responding to the queries using input commands, and the application program generating a completed legal form for electronic signature by the user using the input device and automatic communicating a signed legal form to a legal registration entity using a wireless transceiver.

In one embodiment, the method comprises a mechanism for inputting information required to legally form a corporation, limited liability company, limited partnership or other legal entity, and electronically transmitting such information to a governmental body to establish the existence of the legal entity. Specifically, a mobile device application is offered to a user in which the user answers enumerated questions to provide the information required to form a legal entity. The mobile device application automatically populates the information into electronic documents that, after being electronically signed by the user directly on the mobile device, are suitable for filing with the governmental body. The mobile device application electronically transmits the documents to the filing authority in any of the fifty United States, or other governmental entity, by transmission via facsimile, electronic mail, other electronic communication or some combination of those aforementioned mechanisms. Upon processing of the documents that have been transmitted, the entity's legal existence is established. The method allows the user to form a legal entity solely through the use of a mobile device.

Other features and advantages will be apparent from a review of the entire specification, including the appended claims and drawings.

### BRIEF DESCRIPTION OF THE DRAWINGS

FIG. 1 is a block diagram of an automated system for forming a legal entity using a mobile device;

FIG. 2 is a flow diagram of a user interface routine implemented in the mobile device of FIG. 1;

FIG. 3 is a flow diagram of a method for forming a legal entity using the system of FIG. 1;

FIG. 4 is an exemplary screen displayed for selecting a legal form using the mobile device of FIG. 1;

FIG. 5 is a screen display for responding to queries for a selected legal form using the mobile device of FIG. 1;

FIG. 6 is a screen display, similar to FIG. 5, showing user responses to the queries; and

FIG. 7 is a screen display illustrating a signed legal form to be transferred to a legal registration entity using the mobile device of FIG. 1.

### DETAILED DESCRIPTION

The invention will be primarily described within the context of a system or process adapted to achieve a specific purpose. However, those skilled in the art and informed by the teachings herein will realize that the invention is also applicable to other technical areas and/or embodiments.

One embodiment of the invention comprises an automated process for creating a legal entity solely through the use of a mobile device.

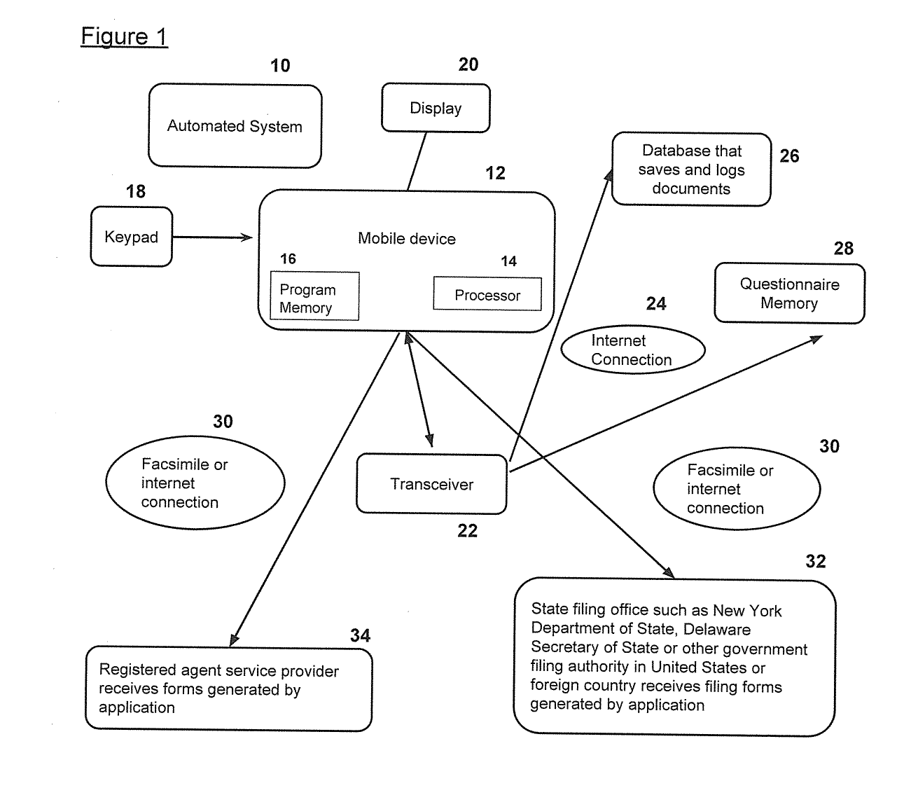

Referring to FIG. 1, an automated system 10 is illustrated for forming the legal entity. The automated system 10 uses a mobile device 12. The mobile device 12 may be, for example, a smart phone, tablet or the like including the functionality of a computer and adapted for wireless remote communication with appropriate governmental bodies, such as legal registration entities through which the legal entity is formed. As is apparent, each state or foreign governmental body has its own predefined procedures and forms for establishing a legal entity.

The mobile device 12 includes a processor 14, a program memory 16, an input device, such as a keypad 18, for entering commands, a display 20 and a wireless transceiver 22 for remote communications.

The processor 14 runs an application program stored in the program memory 16 for implementing a basic operating system and the like as well as applications or software routines, as necessary or desired, under command of the keypad 18 and using the display 20. The keypad 18 may be a physical keypad on the mobile device 12 with individual push buttons or may be integrated into a touch display with the display 20, as is well known.

The transceiver 22 may include circuitry for multiple types of wireless communication such as, for example, cellular communications, Wi-Fi communications, and/or Bluetooth communications. Although not shown, the processor 14 may also be operatively connected with input/output ports such as for connection to USB cables or the like or proprietary cables or memory cards, as necessary or desired. As such, the program memory 16 could be internal memory of the mobile device 12 or memory on a removable memory card.

The mobile device 12 may communicate via various different mediums, as illustrated. For example, the transceiver 22 may communicate via an internet connection 24 through either Wi-Fi communications or cellular communications. The internet connection 24 may provide connection with a remote database 26 and/or a questionnaire memory 28. The questionnaire memory 28 could be part of the database 26, could be internal memory to the mobile device 12 or be a removable memory, as necessary or desired. Moreover, the transceiver may communicate over facsimile or Internet connections 30 to remote entities such as a representative legal registration state filing office 32 or a registered agent service provider 34.

The database 26 stores a plurality of record files comprising legal forms for filing with state registration or other government entities. These may include basic state forms provided by the state filing office, or other governmental body, for filing with the same. These legal forms would be stored in electronic format for access by the mobile device 12. The questionnaire memory 28 stores a plurality of query lists to ascertain relevant data for legal forms. These query lists are used to fill in blanks to present on individual legal forms stored in the database 26.

As described more particularly below, the application program in the mobile device 12 maps select ones of the plurality of query lists to select ones of the legal forms and operates a user interface using the display 20 through which a user enters commands on the keypad 18. These commands include a selection of one of the plurality of legal forms. Responsive thereto, the application program displays the query list for the selected legal form on the display 20 and the user responds to the queries using input commands on the keypad 18. The application program then generates a completed legal form which is shown on the display 20 for electronic signature by the user using the keypad 18. The mobile device 12 subsequently automatically communicates the signed legal form via the transceiver 22 to the state filing office 32 for the particular state or other filing authority for which the selected legal form pertains. A copy of the signed legal form may also be communicated via the transceiver 22 to the registered agent service provider 34 for the user as well as a copy being stored in the database 26 for subsequent access by the user. As will be apparent, the application could be used directly by the registered agent to form a legal entity for a client, thereby eliminating the separate transmission of the completed forms to the registered agent.

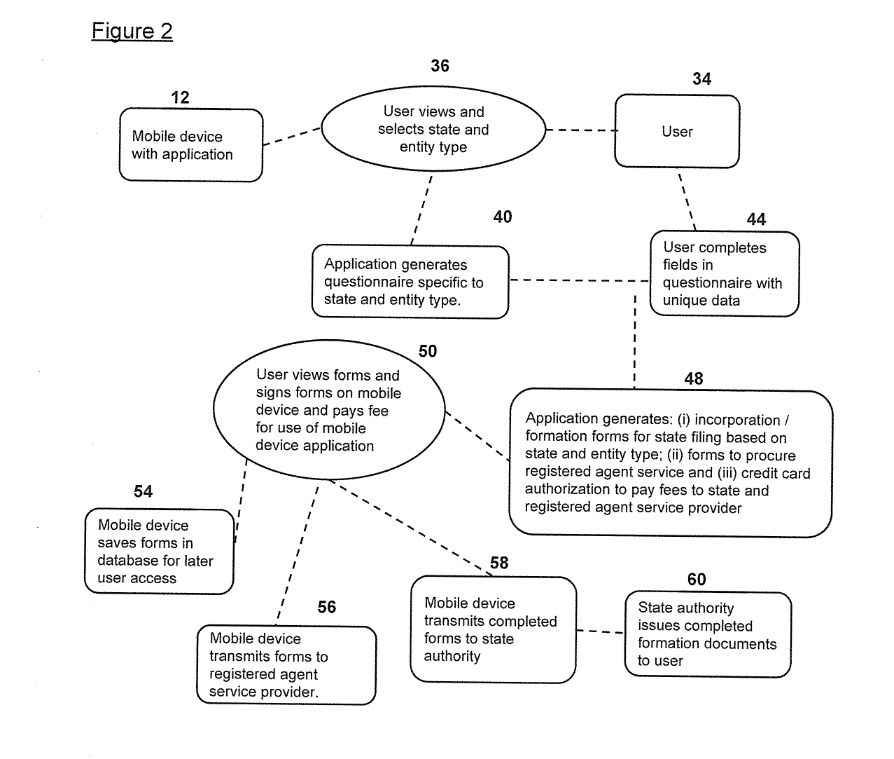

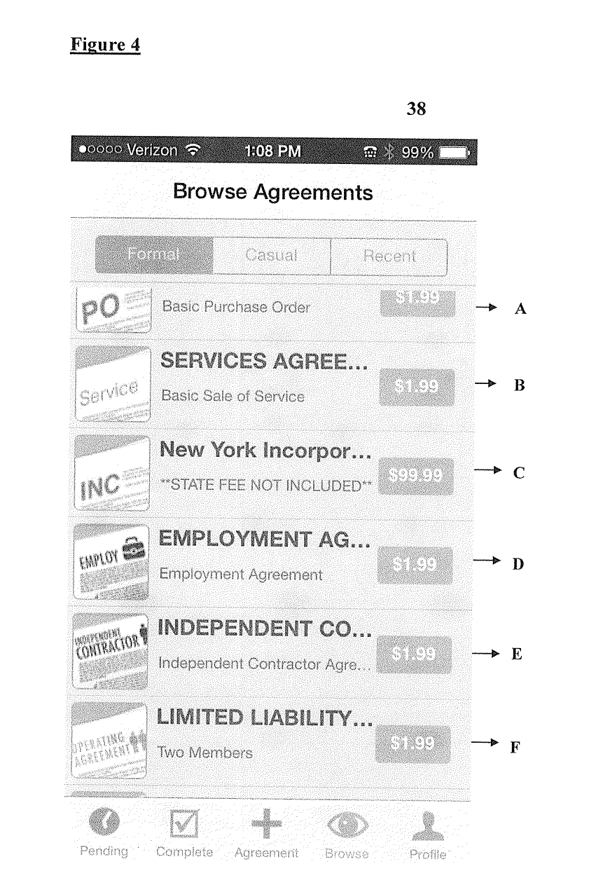

Referring to FIG. 2, a flow diagram illustrates a user interface routine used with the application program for forming a legal entity using the mobile device 12 of FIG. 1. In this figure, the mobile device 12 is illustrated as a single block, as is the user 34. The user interface routine begins at a node 36 where the user views from a menu using the keypad 18 and the display 20 to select a state and entity type. This may comprise, for example, a menu with a listing of available states and for each state a sub-menu listing the types of legal forms available for entry using the mobile device 12. An exemplary display 38 is illustrated in FIG. 4 which lists several available forms, six of which are identified with the letters A-F. Associated with each listing is a general description of the form along with a button indicating the cost associated with the particular form. For example, listing C relates to a New York incorporation form with an identified cost of $99.99. Each form comprises a record file stored in the database 26, see FIG. 1, which includes an electronic file of the blank form as well as other information, including cost for the form to be paid to the application provider, $99.99 for listing C, and to the legal registration entity, which amount is set by the legal registration entity.

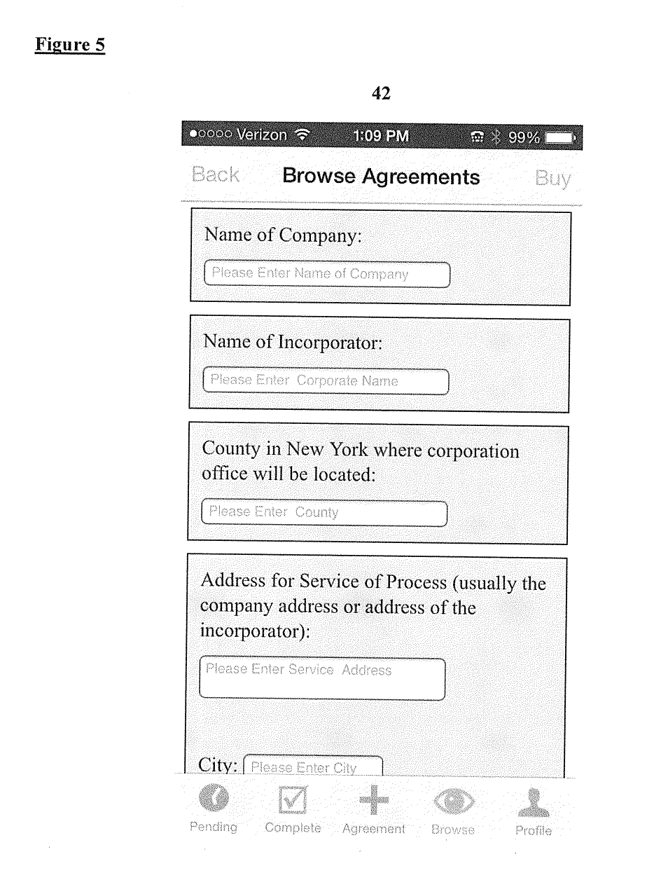

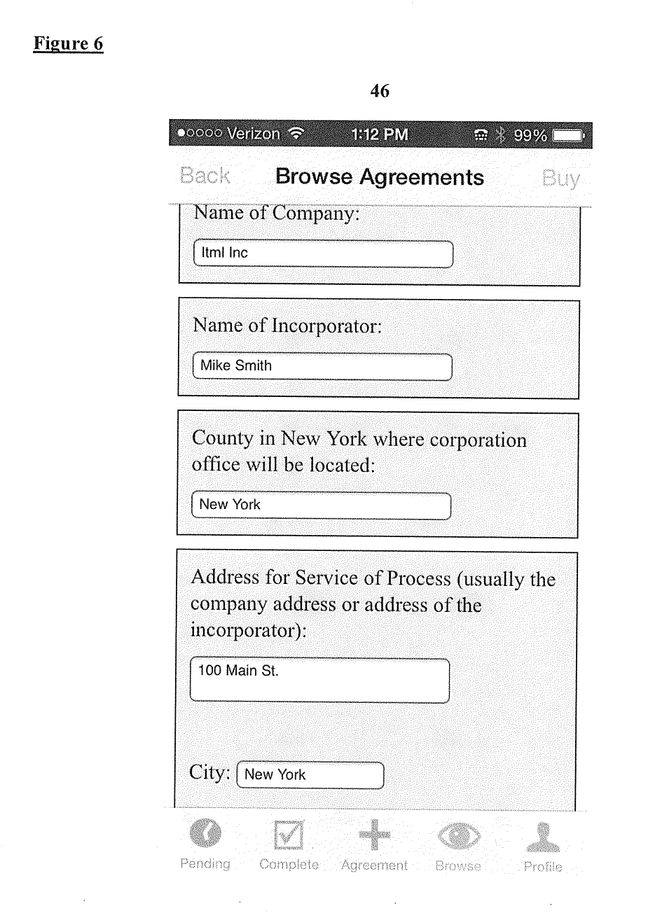

Once the user selects one of the forms A-F at the node 36, then the application program accesses data in the questionnaire memory 28 to select one of the plurality of query lists stored in the questionnaire memory 28 to the particular form. Particularly, the application program selects the query list required to fill in the necessary blank lines in the forms and maps the queries to the particular locations of the blank lines in the form. The application then displays a questionnaire specific to the state and entity type at a block 40. FIG. 5 shows an exemplary display 42 for the questionnaire. This lists the various queries necessary for the user to complete in order to finalize the selected form. The user then completes the fields in the questionnaire with unique data, as shown at a block 44 and illustrated in display 46 of FIG. 6. As is apparent, there may be additional fields in the questionnaire not shown in the display 46 and the user can simply scroll up or down, as necessary, to complete all of the fields.

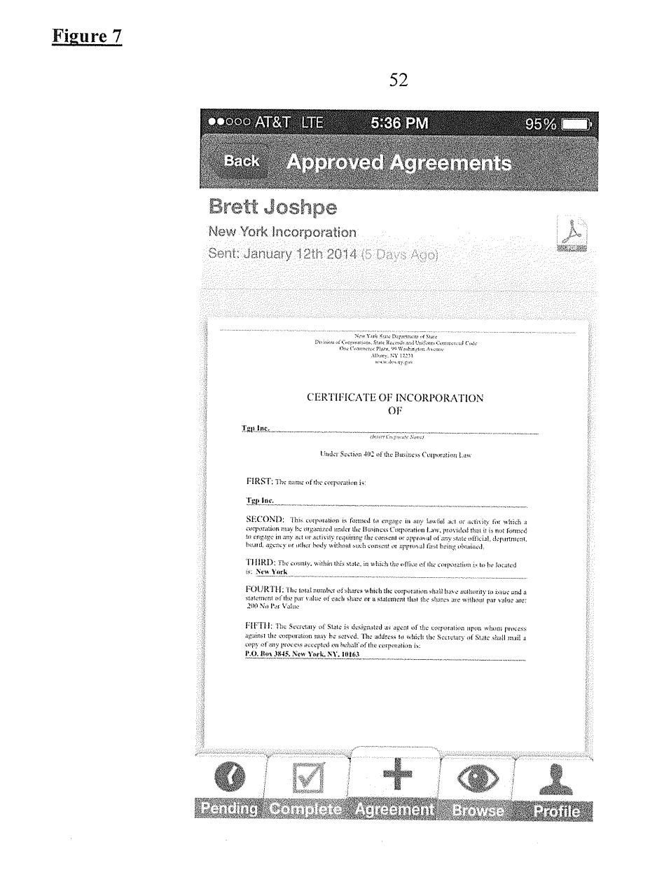

Once the unique data has been entered, then the application program on the mobile device 12 automatically generates the legal registration forms, forms to procure a registered agent and credit card authorization to pay fees to the state and registered agent service provider. These fees are in addition to those identified in FIG. 4 which are paid to the application provider. This is done at a block 48. The user can then view the forms on the display 20 at a block 50 and as shown in the display 52 of FIG. 7. If the form is satisfactory, then the user electronically signs the form on the mobile device 12 and pays the application provider the fee identified in FIG. 4 for use of the mobile device application. How the form is signed is dependent on the particular state registration entity and the user is instructed on signature requirements. The mobile device 12 saves the form in the database 26 at a block 54, transmits the signed form to the registered agent service provider at a block 56 and transmits the completed form and necessary payment to the state authority at a block 58. The state authority will subsequently issue the completed formation documents to the user at a block 60 according to the particular requirements of the governmental body.

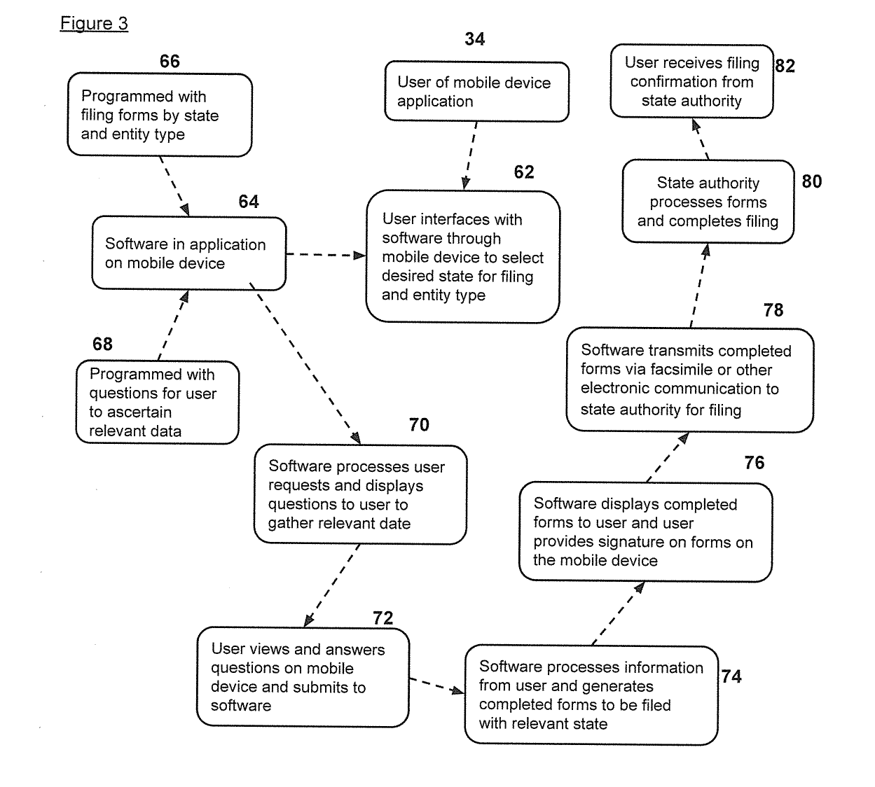

Referring to FIG. 3, a flow diagram illustrates in greater detail the overall software operation for the application program. The user 34 interfaces with the software through the mobile device 12 at a block 62 to access the application software from the program memory 16 at a block 64. The software in the application on the mobile device 12 accesses filing forms by state and entity type stored at a block 66, from the database 26, and accesses questions for users to ascertain relevant data stored at a block 68, from the questionnaire memory 28. The application software then processes the user request using the mapping function, discussed above, at a block 70 to display the questions to the user to gather the relevant data. The answers are submitted to the software at the block 72 which processes the information and generates the completed forms at a block 74. The software displays the completed form to the user at a block 76 and awaits the user providing a signature on the forms on the mobile device 12. The form of the signature will depend on the requirements of the particular governmental body, as discussed above. The application transmits the completed forms via facsimile or other electronic communication to the state authority for filing and to the registered agent service provider at a block 78. The state authority processes the forms and indicates that filing is complete at a block 80 and the user receives filing confirmation from the state authority at a block 82.

The above described system and process enables users to form legal entities solely through the use of a mobile device. Advantageously, the methodology described herein does not require the users to print paper documents or scan signed documents.

This embodiment provides a method for creating a legal entity solely on a mobile device. The features of the process include one or more of the following: the user is required to input answers to questions presented by the mobile device application; the mobile device application compiles the information into a format suitable for filing with state authorities; the user must sign the user's name to the documents on the screen of the mobile device; the mobile device application electronically transmits the signed documents to the filing authorities in any of the fifty United States or a foreign government by sending via facsimile, electronic mail, other electronic communication or some combination of those aforementioned mechanisms; and/or the executed documents are saved and logged as part of the user's profile on the mobile device application.

Components of an exemplary embodiment comprise mobile devices capable of running the application, and a website and database. Once documents are executed, the web-based database saves and logs the documents executed by users of the application.

There are numerous advantages of the illustrated embodiments. This includes simple execution of filing documents. Compiling the documentation to conventionally form a legal entity takes multiple steps that typically involve printing, signing and/or scanning paper versions of the filing documents. This method eliminates the typical steps for completing the documents by allowing users to execute the documents solely through the use of a mobile device.

Forming a legal entity typically requires the filer to determine the proper recipient of the filing documents and to transmit the documents via mail or electronic transmission. This method automates the transmission process so that the filer only has to respond to the questions presented by the mobile device application, which automatically transmits the documents to the proper recipient.

The present invention has been described with respect to flowcharts and block diagrams. It will be understood that each block of the flowchart and block diagrams can be implemented by computer readable program instructions. These program instructions may be provided to a processor to produce a machine, such that the instructions which execute on the processor create means for implementing the functions specified in the blocks. The computer program instructions may be executed by a processor to cause a series of operational steps to be performed by the processor to produce a computer implemented process such that the instructions which execute on the processor provide steps for implementing the functions specified in the blocks. Accordingly, the illustrations support combinations of means for performing a specified function and combinations of steps for performing the specified functions. It will also be understood that each block and combination of blocks can be implemented by special purpose hardware-based systems which perform the specified functions or steps, or combinations of special purpose hardware and computer instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

It will be appreciated by those skilled in the art that there are many possible modifications to be made to the specific forms of the features and components of the disclosed embodiments while keeping within the spirit of the concepts disclosed herein. Accordingly, no limitations to the specific forms of the embodiments disclosed herein should be read into the claims unless expressly recited in the claims. Although a few embodiments have been described in detail above, other modifications are possible. For example, the logic flows depicted in the figures do not require the particular order shown, or sequential order, to achieve desirable results. Other steps may be provided, or steps may be eliminated, from the described flows, and other components may be added to, or removed from, the described systems. Other embodiments may be within the scope of the following claims.

1. An automated system for forming a legal entity, comprising:
a database for storing a plurality of record files comprising legal forms for filing with state registration entities;
a questionnaire memory for storing a plurality of query lists to ascertain relevant data for legal forms;
a mobile device operatively associated with the computer database and the questionnaire memory, and including a programmed processor, program memory, an input device for entering commands, a display, and a wireless transceiver for remote communications, the processor running an application program stored in the program memory, the application program mapping select ones of the plurality of query lists to select ones of the legal forms, and the application program operating a user interface using the display through which a user enters commands on the input device including a selection of one of the plurality of legal forms, and responsive thereto the application program displaying the query list for the selected legal form, and the user responding to the query list using input commands, whereby the application program generates a completed legal form for electronic signature by the user using the input device and subsequent automatic communication of the signed legal form to the legal registration entity using the transceiver.

2. The automated system for forming a legal entity of claim 1 wherein the mobile processing device operatively communicates with the database using the transceiver.

3. The automated system for forming a legal entity of claim 2 wherein the transceiver communicates with the database over the internet.

4. The automated system for forming a legal entity of claim 1 wherein the mobile processing device operatively communicates with the questionnaire memory using the transceiver.

5. The automated system for forming a legal entity of claim 1 wherein the record files include data representing cost for each of the plurality of legal forms and wherein the application program, responsive to the user entering commands to select one of the plurality of legal forms, implements a payment routine for the cost associated with the select one of the plurality of legal forms.

6. The automated system for forming a legal entity of claim 1 wherein the mobile processing device automatically communicates the signed legal form to a registered agent using the transceiver.

7. The automated system for forming a legal entity of claim 1 wherein the application program is operative to save the signed legal form in the database.

8. The automated system for forming a legal entity of claim 1 wherein the database stores a plurality of user profile files representing identification information and payment information for a user.

9. A method for forming a legal entity using mobile devices, comprising:
providing a database for storing a plurality of record files comprising legal forms for filing with state registration entities;
providing a questionnaire memory for storing a plurality of query lists to ascertain relevant data for legal forms;
a user operating an application program using a mobile processing device which is in operative communication with the computer database and the questionnaire memory, the application program mapping select ones of the plurality of query lists to select ones of the legal forms, and operating a user interface using a display through which a user enters commands on an input device, the commands including a selection of one of the plurality of legal forms, and responsive thereto the application program displaying the query list for the selected legal form, and the user responding to the query list using input commands, and the application program generating a completed legal form for electronic signature by the user using the input device and automatically communicating a signed legal form to a legal registration entity using a wireless transceiver.

10. The automated system for forming a legal entity of claim 9 wherein the mobile processing device operatively communicates with the database using the transceiver.

11. The automated system for forming a legal entity of claim 10 wherein the transceiver communicates with the database over the internet.

12. The automated system for forming a legal entity of claim 9 wherein the mobile processing device operatively communicates with the questionnaire memory using the transceiver.

13. The automated system for forming a legal entity of claim 9 wherein the record files include data representing cost for each of the plurality of legal forms and wherein the application program, responsive to the user entering commands to select one of the plurality of legal forms, implements a payment routine for the cost associated with the select one of the plurality of legal forms.

14. The automated system for forming a legal entity of claim 9 wherein the mobile processing device automatically communicates the signed legal form to a registered agent using the transceiver.

15. The automated system for forming a legal entity of claim 9 wherein the application program saves the signed legal form in the database.

16. The automated system for forming a legal entity of claim 9 wherein the database stores a plurality of user profile files representing identification information and payment information for a user.
